(19) United States
(12) Patent Application Publication
(10) Pub. No.: US 2006/0110969 A1
(43) Pub. Date: May 25, 2006

(54) Cable assembly having improved latch

(75) Inventors: Jerry Wu, Irvine, CA (US); Wei-Ya Cheng, Kunsan (CN); Sufeng Liu, Kunsan (CN)

Correspondence Address: GEOFFREY G. HASELDEN, 12 HIGH ASH DRIVE, LEEDS LS17 8RA, GB

(73) Assignee: HON HAI PRECISION IND. CO., LTD.

(21) Appl. No.: 11/166,673

(22) Filed: Jun. 23, 2005

(30) Foreign Application Priority Data
Nov. 23, 2004 (CN) 2004201095161

(51) Int. Cl. H01R 13/627

(52) U.S. Cl. 439/352

(57) ABSTRACT

A cable assembly (1) includes a connector (10) including a connector housing (2) with a plurality of terminals (6) assembled therein, at least a cable (4) including a number of conductive wires (40) electrically connected to the terminals (6). The connector housing (2) defines at least a top surface (204) and a mating face (205) having a jointing line (206) therebetween. A first latch (501) has a first anchoring end (5011) cantilevered from the jointing line (206) and extending upward and backward therefrom and a second latch (503) has a second anchoring end (5031) cantilevered from the jointing line (206) in parallel to the first latch (501), and extending upward and backward therefrom.

### CROSS-REFERENCE TO RELATED APPLICATION

This application is related to U.S. patent application Ser. No. 10/988,674 filed on Nov. 15, 2004, invented by Jerry Wu, entitled “CABLE END CONNECTOR HAVING INTEGRAL LATCH MEANS”, which is assigned to same assignee as this application.

### BACKGROUND OF THE INVENTION

1. Field of the Invention

The present invention relates generally to a cable assembly, and particularly to a cable assembly having a latch to effect its engagement and disengagement with a complementary connector.

2. Description of Related Arts

Many electrical connectors include latch means for securely but releasably retaining a pair of electrical connector housings in a mated condition. More particularly, these conventional connectors include mateable pairs of molded plastic housings, each of which is constructed to receive a plurality of terminals therein. The terminals of one housing electrically contact the terminals of the other housing when the housings are in their mated condition.

For example, U.S. Pat. No. 4,986,766 which issued to Molex on Jan. 22, 1991 shows a conventional electrical connector with a latch integrally and pivotally connected to a corresponding connector. The latch comprises a base connecting the latch to outer surface of the electrical connector, a deflectable portion extending from the base to a remote end that is deflectable relative to the outer surface of the electrical connector. The deflectable portion defines a locking protrusion outwardly extending from the midst thereof. During engagement/disengagement, the user applies a downward force to a depressible actuator of the latch for either locking or releasing the electrical connector from the complementary connector. Such downward force exerted on the depressible actuator of the latch could actuate the latch, which makes the latch return to its original position by its own restorative force with the locking protrusion engaging with corresponding structure on the complementary connector in a mating process or allows the locking protrusion to disengage from corresponding structure on the complementary connector in an unmating process. In practice, the user will actuate the latch excessively for acquiring enough restorative force, thereby causing the latch to break or be of reduced effectiveness.

Another U.S. Pat. No. 6,364,685 B1 which issued on Apr. 2, 2002 also shows an electrical connector 10 having an articulated latch 12. The articulated latch 12 comprises a first section 14 with a proximate end 18 being joined to the forepart of the housing 11, a second section 15 downwardly and inwardly extending from the first section 14 with a distal end 1 being joined to the surface of the housing 11. This design solves the problem in U.S. Pat. No. 4,986,766. When the latch 12 is actuated, the first section 14 and the second section 15 move to maintain a substantially parallel relationship, which all have trendy to return to their original positions, thereby, increasing the latch's restorative force and causing the engagement structure 13 of the housing 11 to mate with the complementary connector more conveniently. However, because the first section 14 and the second section 15 are arranged in a horizontal plane, as the latch 12 is actuated, the first section 14 will abut against the second section 15, thereby, taking up much space in the horizontal direction between the latch 12 and the surface of the housing 11 and preventing the latch 12 being actuated adequately.

Hence, a cable assembly having improved latch is desired.

### SUMMARY OF THE INVENTION

Accordingly, the object of the present invention is to provide a cable assembly having improved anti-overstress latch, thereby, preventing the latch from being broken or reducing effectiveness.

The another object of the present invention is to provide a cable assembly having improved latch, thereby, adapting to comply with the miniature trend of current electrical connectors.

To achieve the above objects, a cable assembly in according with the present invention comprises a connector including a connector housing assembled with a plurality of terminals, at least a cable including a plurality of conductive wires electrically connected to the terminals. The connector housing defines at least a top surface and a mating face having a jointing line therebetween. The connector further comprises a first latch having a first anchoring end cantilevered from the jointing line and extending upward and backward therefrom and a second latch having a second anchoring end cantilevered from the jointing line in parallel to the first latch, and extending upward and backward therefrom.

Other objects, advantages and novel features of the invention will become more apparent from the following detailed description of the present embodiment when taken in conjunction with the accompanying drawings.

### BRIEF DESCRIPTION OF THE DRAWING

FIG. 1 is a perspective, assembled view of a cable assembly in accordance with the present invention;

FIG. 2 is a perspective, exploded view of the cable assembly of FIG. 1;

FIG. 3 is a view similar to FIG. 2, but taken from a different aspect; and

FIG. 4 is a cross sectional view of the cable assembly of FIG. 1.

### DETAILED DESCRIPTION OF THE PREFERRED EMBODIMENT

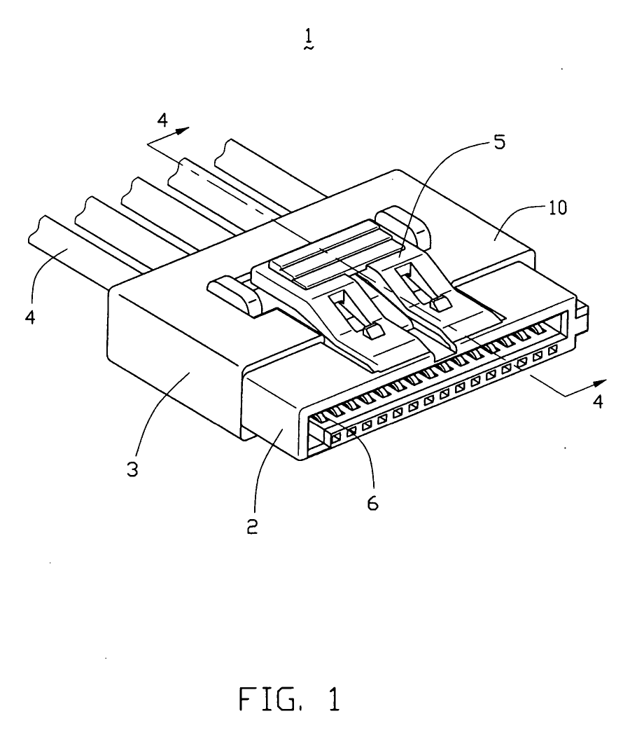

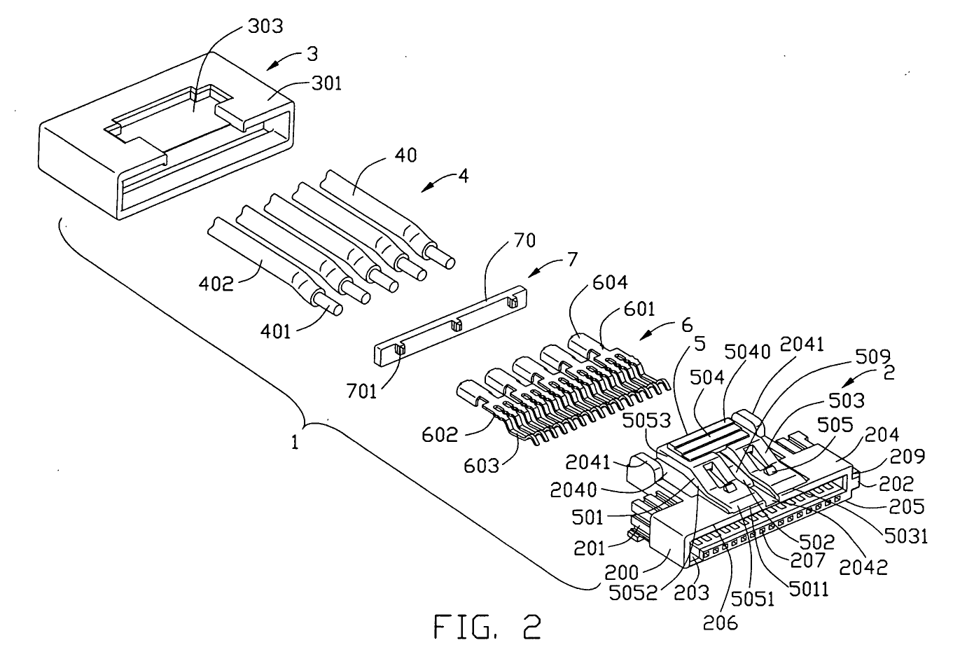

Referring to FIGS. 1-2, a cable assembly 1 in accordance with the present invention comprises a connector 10 including a connector housing 2 with a plurality of terminals 6 assembled therein, at least a cable 4 connected to the terminals 6. The connector 10 further comprises a latch structure 5 integrally molded with the connector housing 2, a spacer 7 assembled to the connector housing 2, and a casing 3 enclosing the rear end of the connector housing 2 and the front end of the cable 4.

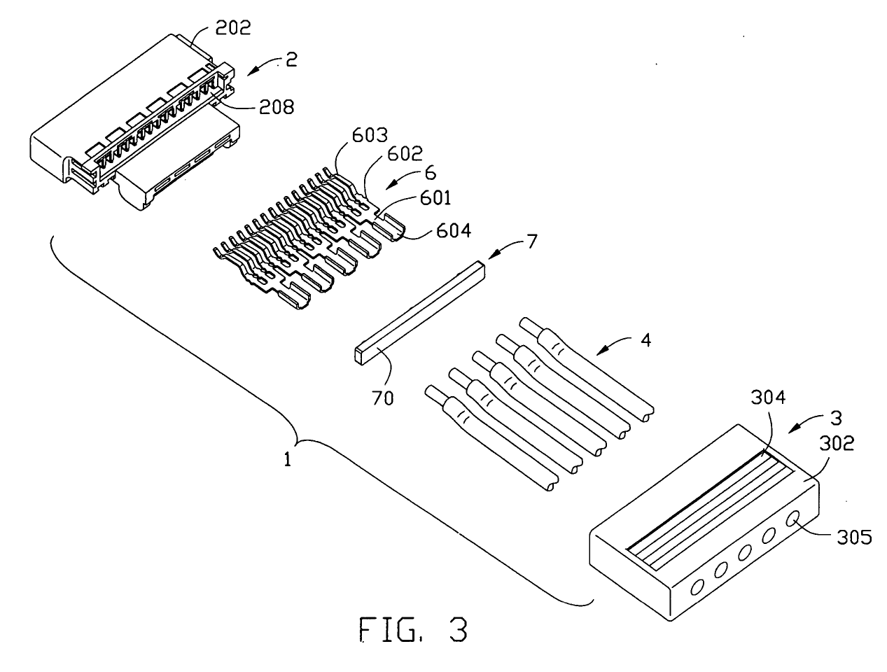

Referring to FIGS. 2-3, the connector housing 2 comprises a main portion 200 with a rectangular configuration, an extending portion 201 rearwardly extending from the main portion 200. The main portion 200 defines at least a top surface 204, a mating face 205. The top surface 204 and the mating face 205 form a jointing line 206 at the cross thereof. In addition, a guiding bar 202 projects outwardly from a side wall 209 for guiding the connector 10 to mate with the complementary connector properly. A receiving cavity 203 with a L-shaped configuration for receiving a tongue (not shown) of the complementary connector penetrates through the main portion 200 from the mating face 205 to a rear surface 208 of the extending portion 201. A plurality of terminal channels 207 are formed in the main portion 200, and penetrate through the main portion 200 and the extending portion 201. The connector housing 2 further defines a support portion 2040 rearwardly extending from the main portion 200 and beyond the extending portion 201. A pair of protrusions 2041 are respectively disposed on opposite sides of the support portion 2040 for preventing the external material from hooking with the latch structure 5. Certainly, the support portion 2040 can be with some configurations, such as U-shape or flat-shape. If only, there is enough space between the surface of the support portion 2040 and the latch structure 5 for the actuation of the latch structure 5.

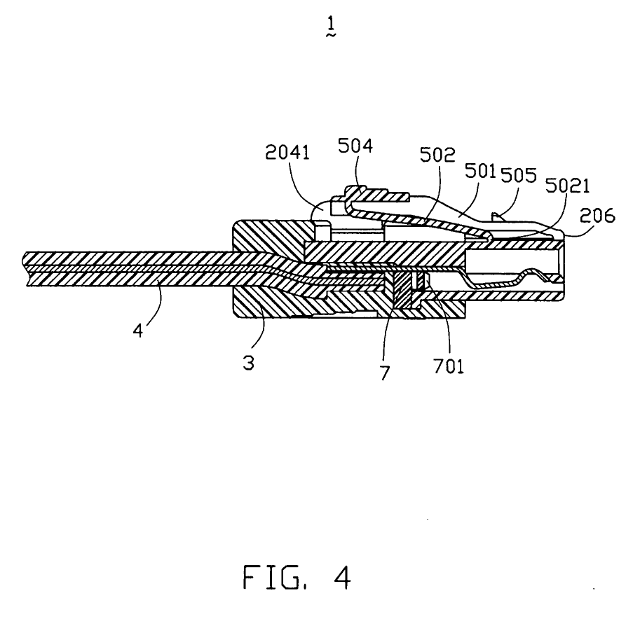

In conjunction with FIG. 4, the latch structure 5 comprises a first latch 501, a second latch 503 in parallel to the first latch 501, a depressible release actuator 504 integrally molded with the first and second latches 501, 503, and a biasing arm 502 forwardly and downwardly extending from a bottom surface of the depressible release actuator 504 and located between the first and second latches 501, 503. The first latch 501 includes a first anchoring end 5011 cantilevered from the jointing line 206 and extending upwardly and backwardly from the jointing line 206. The second latch 503 disposed in spaced relationship to the first latch 501 also includes a second anchoring end 5031 cantilevered from the jointing line 206 of the connector housing 2 and extending upwardly and backwardly from the jointing line 206. The first latch 501 has a similar structure to that of the second latch 503. The first and second latches 501, 503 each comprises a base portion 5051 extending unitarily from the first anchoring end 5011 and the second anchoring end 5031 respectively, a cantilevered portion 5053 integrally molded with the depressible release actuator 504 and disposed in spaced relationship to the support portion 2040, and a deflectable arm portion 5052 connecting the base portion 5051 to the cantilevered portion 5053. Each base portion 5051 has a ramped locking protrusion 505 formed thereon. The biasing arm 502 extends from the depressible release actuator 504 toward the top surface 204 of the connector housing 2 with a front end 5021 integrally molded with the top surface 204. It is noted that the width of the biasing arm 502 is slightly smaller than a dimension of the gap 509 between the first and second latches 501, 503. The front end 5021 is disposed in the slot 2042 hollowly formed in the top surface 204 in a back-to-front direction and behind the jointing line 206, thereby allowing the latch structure 5 to gain enough restorative force. The depressible release actuator 504 defines a plurality of steps 5040 for providing enough friction to grasp. Attentively, the slot 2042 opposite to the gap 509 has the same width as that of the gap 509. Obviously, in alternative embodiment of the present invention, the front end 5021 of the biasing arm 502 is not connected to the top surface 204, but rather than slide along the slot 2042 in a back-to-front direction.

Referring to FIGS. 2-4, the casing 3 is generally of a rectangular configuration and comprises a top face 301, a lower face 302 opposite to the top face 301. A many-sided opening 303 is disposed in the top face 301 for receiving the latch structure 5 therein. A plurality of parallel ribs 304 are formed on the lower face 302 for being grasped conveniently. The casing 3 further comprises a rear face (not labeled) which defining a plurality of apertures 305 for allowing the extending through of the cable 4 to engage with the terminals 6 respectively.

The cable 4 comprises a plurality of wires 40. Each wire 40 comprises a conductor core 401 soldered with the corresponding terminal 6, and an outer insulating cover 402 enwrapping the conductor core 401.

Each terminal 6 has a folk-shaped configuration and comprises a base 601, three retention portions 602 extending forwardly from the base 601, three mating ends 603 extending forwardly from corresponding retention portions 602, and a U-shaped tail end 604 extending rearwardly from the base 601. The conductor cores 401 are respectively received in corresponding U-shaped tail ends 604 for establishing electrical connection.

The spacer 7 comprises a body portion 70 generally of a rectangular configuration. A plurality of protruding ribs 701 projects forwardly from an edge of the body portion 70.

In assembly, referring to FIGS. 1-4, the terminals 6 are first inserted in the terminal receiving channels 207 respectively in a rear-to-front direction until the retention portions 602 of the terminals 6 abut against the outer surface of the channels 207. Then, the spacer 7 is pushed and received into the connector housing 2 with the protruding ribs 701 tightly abutting against the bases 601 of the terminals 6 so as to secure the terminals 6 to the connector housing 2. The spacer 7 substantially seals the terminal receiving channels 207 and efficiently prevents the melting plastic material of the casing 3 from entering into the channels 207 and influencing the electrical connection between the cable assembly 1 and the complementary connector. Next, the conductor cores 401 are received into and soldered to the U-shaped tail ends 604 of the terminals 6, respectively. The conductor cores 401 are constrained within the U-shaped tail ends 604 to prevent the wires 40 from any displacement and assure a reliable connection therebetween. Finally, the casing 3 is over-molded with the rear end of the connector housing 2 and the front end of the cable 4. The protrusions 2041 are partially received in the opening 303 for preventing the external material from hooking with the latch structure 5.

It is noted that the first latch 501 and the second latch 503 extend from the jointing line 206, which is different from the description of the U.S. Pat. No. 4,986,766 that the latch just extends from the top surface of the housing. So, the latch structure 5 takes up relatively less space of the complementary connector in a locking condition, thereby adapting to comply with the miniature trend of current electrical connectors.

In mating, the latch structure 5 is deflected toward the surface of the support portion 2040 because of a directed mateable insertion of the connector housing 2 into a corresponding housing (not shown) of the complementary connector. Obviously, depending upon sufficient insertion of the connector housing 2 into the corresponding housing, the locking protrusions 505 will align with the locking apertures (not shown) of the complementary connector to permit the latch structure 5 to resiliently return to its unbiased condition for securely but releasably holding the two connectors in a mated condition. In disengagement, a force exerted on the depressible release actuator 504 to urge the latch structure 5 toward the surface of the Support portion 2040 will disengage the locking protrusion 505 from the locking aperture of the complementary connector. The problem discussed in the prior art is solved as follow. When overstressing the latch structure 5, the biasing arm 502 is deflected and penetrates through the gap 509 or slides on the slot 2042 of the connector housing 2. Thus, the first and second latches 501, 503 do not abut against the biasing arm 502, thereby increasing the elasticity and the effectiveness of the latch structure 5, and providing an enough free space for operation.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A cable assembly, comprising:
a connector including a connector housing assembled with a plurality of terminals;
at least a cable including a plurality of conductive wires electrically connected to the terminals;
wherein the connector housing defines at least a top surface and a mating face having a jointing line therebetween;
a first latch having a first anchoring end cantilevered from the jointing line and extending upward and backward therefrom; and
a second latch having a second anchoring end cantilevered from the jointing line in parallel to the first latch, and extending upward and backward therefrom.

2. The cable assembly as described in claim 1, wherein the first latch and the second latch connect each other by a depressible release actuator for actuating the first and second latches conveniently.

3. The cable assembly as described in claim 2, wherein the first latch and second latch together form a gap therebetween.

4. The cable assembly as described in claim 3, wherein the top surface includes a hollow slot disposed between the first latch and the second latch and opposite to the gap.

5. The cable assembly as described in claim 4, wherein the connector housing further comprises a biasing arm forwardly and downwardly extending from the depressible release actuator.

6. The cable assembly as described in claim 5, wherein the biasing arm is located between the first latch and the second latch.

7. The cable assembly as described in claim 6, wherein the biasing arm comprises a front end disposed in the slot and behind the jointing line.

8. The cable assembly connector as described in claim 7, wherein the front end of the biasing arm can slide over the slot and penetrate through the gap.

9. The cable assembly as described in claim 1, wherein the connector further comprises a casing for integrally over-molded the rear end of the connector housing and the front end of the at least one cable.

10. The cable assembly as described in claim 2, wherein the first latch and the second latch each comprises a base portion extending unitarily from the first anchoring end and the second anchoring end respectively, a cantilevered portion integrally molded with the depressible release actuator, and a deflectable arm portion connecting the base portion to the cantilevered portion.

11. The cable assembly as described in claim 10, wherein the base portion comprises a locking protrusion formed thereon.

12. The cable assembly as described in claim 1, wherein the connector further comprises a spacer assembled to the connector housing for securing the terminals and preventing the melting plastic material from entering into the connector housing and influencing the electrical connection.

13. The cable assembly as described in claim 1, wherein the connector housing further comprises a main portion, a supporting portion extending from the main portion with a pair of protrusions formed thereon.

14. The cable assembly as described in claim 13, wherein the main portion comprises a receiving cavity with a L-shaped configuration.

15. The cable assembly as described in claim 1, wherein each terminal comprises a base, a U-shaped tail end extending rearwardly from the base, and three mating ends opposite to corresponding base.

16. A cable assembly comprising:
a connector including a connector housing assembled with a plurality of terminals;
at least a cable including a plurality of conductive wires electrically connected to the terminals;
wherein the connector defines a top surface and a mating face having a jointing line therebetween, the connector housing defines a main portion;
a latch structure cantilevered from the jointing line and extending upward and backward therefrom;
a supporting portion backwardly extending from the main portion for gaining enough space between the latch structure and the supporting portion.

17. The cable assembly as described in claim 16, wherein the supporting portion with an U-shaped configuration rearwardly extending from the main portion toward a free end.

18. The cable assembly as described in claim 17, wherein the supporting portion comprises a pair of protrusions respectively disposed on opposite sides of the supporting portion for preventing the external material from hooking with the latch structure.

19. A cable assembly comprising:
a connector including a housing assembly with a plurality of contacts therein;
a cable including a plurality of conductive wires electrically connected to the corresponding contacts, respectively;
a cantilever type latch structure extending along a front-to-back direction, said latch structure including a latch section extending along said front-to-back direction and having a locking device thereon, and further including a biasing arm extending along said front-to-back direction while spaced from said latch section in a transverse direction perpendicular to said front-to-back direction; wherein both said latch section and said biasing arm are integrally linked to the housing assembly via respective fulcrum ends under a condition that said fulcrum ends are located at different positions in said front-to-back direction.

20. The cable assembly as claimed in claim 19, wherein the fulcrum end of the biasing arm is located behind that of the latch section in said front-to-back direction.
